(19) United States
(12) Patent Application Publication
(10) Pub. No.: US 2022/0366752 A1
(43) Pub. Date: Nov. 17, 2022

(54) CODED POLYMER SUBSTRATES FOR BANKNOTE AUTHENTICATION

(71) Applicant: Spectra Systems Corporation, Providence, RI (US)

(72) Inventor: Nabil Lawandy, Saunderstown, RI (US)

(21) Appl. No.: 17/831,014

(22) Filed: Jun. 2, 2022

Related U.S. Application Data
(63) Continuation-in-part of application No. PCT/US20/62872, filed on Dec. 2, 2020.
Application No. PCT/US20/62872 is a continuation of application No. 16/702,088, filed on Dec. 3, 2019, now Pat. No. 11,263,856.
Application No. 16/702,088 is a continuation-in-part of application No. 15/909,170, filed on Mar. 1, 2018.
(60) Provisional application No. 63/312,432, filed on Feb. 22, 2022.
(60) Provisional application No. 62/465,587, filed on Mar. 1, 2017.

(51) Int. Cl. G07D 7/202; G07D 7/1205; G07D 7/121

(52) U.S. Cl. CPC G07D 7/205; G07D 7/1205; G07D 7/121; B42D 25/36

(57) ABSTRACT

A system and associated method, the system including an item including a substrate including a polymer material and a first diffraction feature configured to diffract incident radiation into the substrate at an angle greater than the critical angle and launch the incident radiation into a waveguide transmission mode within the substrate to transmit the incident radiation laterally within the substrate, and a computing device including a radiation source configured to irradiate the item at a location of the first diffraction feature directly or indirectly on or within the substrate such that radiation is transmitted laterally within the substrate and a camera configured to measure emitted radiation from the substrate after lateral transmission of the incident radiation, where, in connection with irradiating with the radiation source and measuring the emitted radiation with the camera, the computing device is disposed in contact with the substrate.

### CROSS-REFERENCE TO RELATED APPLICATIONS

This application claims priority to U.S. provisional application Ser. No. 63/312,432, filed Feb. 22, 2022, now pending, and is a continuation-in-part of PCT international patent application Ser. No. PCT/US20/62872, filed Dec. 2, 2020, which claims priority to U.S. patent application Ser. No. 16/702,088, filed Dec. 3, 2019, now U.S. Pat. No. 11,263,856, issued Mar. 1, 2022, which is a continuation-in-part of U.S. patent application Ser. No. 15/909,170, filed Mar. 1, 2018, now pending, which claims priority to U.S. provisional application Ser. No. 62/465,587, filed Mar. 1, 2017, now expired.

### TECHNICAL FIELD

The present invention relates generally to apparatus and methods for coding items with polymer substrates including doping materials, the codes being detectable in the form of patterned radiation spectra in response to incident radiation.

### BACKGROUND OF THE INVENTION

Counterfeiting is a growing concern and, as a result, secure instruments such as banknotes typically have three levels of authentication. Level I authentication is for public uses and is typically in the form of an optical effect, such as optically variable ink or security threads with optical characteristics that are relatively unique and difficult to duplicate. These Level I authentication features include holographic threads and lenticular lens array security threads. Paper banknotes have included Level I authentication features in the form of watermarks.

Similar to Level I authentication features, Level II authentication features are typically known to the public and commercial banks, and include features such as magnetics and fluorescent and phosphorescent inks, which can be read by simple sensors commonly used in ATMs and bill acceptors.

Level III security features are machine readable features and are more sophisticated than Level II authentication features. Level III security features are typically not known to the public and commercial banks and are used to protect against threats from state-sponsored counterfeiters and other well-funded organizations. The covert Level III authentication features are typically either in the form of inks or other features embedded in the substrate of the banknotes.

Over the last two decades, polymer banknotes have gradually been gaining market share in the banknote industry, with over thirty countries using polymer substrates including materials such as biaxially oriented poly-propylene (BOPP). The use of polymer substrates has been primarily restricted to lower denominations, as most of the Level III security features that have been employed within paper banknote substrates are not available or suitable for use with polymer banknotes.

The present invention concerns a new Level III security feature in the form of a machine readable technology for use with polymer banknotes.

### SUMMARY OF THE INVENTION

In general, in one aspect, the invention features a method including providing an item including a substrate including a polymer material and a first diffraction feature disposed directly or indirectly on or within the substrate, the first diffraction feature configured to diffract incident radiation into the substrate at an angle greater than a critical angle and launch the incident radiation into a waveguide transmission mode within the substrate to transmit the incident radiation laterally within the substrate; irradiating, with a radiation source, the item at a location of the first diffraction feature directly or indirectly on or within the substrate; and measuring, with a camera, emitted radiation from the substrate after lateral transmission of the incident radiation; where the radiation source and the camera are included in a computing device; and where the computing device is disposed in contact with the substrate when irradiating with the radiation source and measuring the emitted radiation with the camera.

Implementations of the invention may include one or more of the following features. The first diffraction feature may be a first grating, and the first grating may be disposed directly or indirectly on or within the substrate by embossing, deposition, curing with an interference pattern using ultraviolet curable ink, or writing using ultraviolet induced changes in the refractive index of the polymer material of the substrate utilizing two interfering lasers. The first diffraction feature may be a first prism including an air gap, a first lens, or a first ball lens disposed directly or indirectly on the substrate.

The method may further include emitting the emitted radiation at a second diffraction feature disposed directly or indirectly on or within the substrate, the second diffraction feature configured to decouple the incident radiation from the waveguide transmission mode after lateral transmission within the substrate, where the second diffraction feature is disposed a predetermined distance from the first diffraction feature. The substrate may further include a doping material configured to laterally transmit the incident radiation within the substrate or a fluorescent material configured to fluoresce in response to the irradiating. The item may be currency, a security thread, or a credit card. The computing device may be a smartphone or a tablet.

In general, in another aspect, the invention features a system including an item including a substrate including a polymer material and a first diffraction feature disposed directly or indirectly on or within the substrate, the first diffraction feature configured to diffract incident radiation into the substrate at an angle greater than the critical angle and launch the incident radiation into a waveguide transmission mode within the substrate to transmit the incident radiation laterally within the substrate; and a computing device capable of being disposed in contact with the substrate, the computing device including a radiation source configured to irradiate the item at a location of the first diffraction feature directly or indirectly on or within the substrate such that radiation is transmitted laterally within the substrate and a camera configured to measure emitted radiation from the substrate after lateral transmission of the incident radiation; where, in connection with irradiating with the radiation source and measuring the emitted radiation with the camera, the computing device is disposed in contact with the substrate.

Implementations of the invention may include one or more of the following features. The first diffraction feature may be a first grating, and the first grating may be disposed directly or indirectly on or within the substrate by embossing, deposition, curing with an interference pattern using ultraviolet curable ink, or writing using ultraviolet induced changes in the refractive index of the polymer material of the substrate utilizing two interfering lasers. The first diffraction feature may be a first prism including an air gap, a first lens, or a first ball lens disposed directly or indirectly on the substrate.

The item may further include a second diffraction feature disposed directly or indirectly on or within the substrate, the second diffraction feature configured to decouple the incident radiation from the waveguide transmission mode after lateral transmission within the substrate, where the second diffraction feature is disposed a predetermined distance from the first diffraction feature. The substrate may further include a doping material configured to laterally transmit the incident radiation within the substrate or a fluorescent material configured to fluoresce in response to the irradiating. The item may be currency, a security thread, or a credit card. The computing device may be a smartphone or a tablet.

In general, in another aspect, the invention features a method including providing an item including a substrate including a polymer material and a doping material, the polymer material and the doping material configured to couple incident radiation and launch the incident radiation into a waveguide transmission mode within the substrate to transmit the incident radiation laterally within the substrate; irradiating, with a radiation source, the item at a first location of the substrate, the first location of the substrate including the doping material; and measuring, with a camera, emitted radiation from the substrate after lateral transmission of the incident radiation; where the radiation source and the camera are included in a computing device; where the computing device is disposed in contact with the substrate when irradiating with the radiation source and measuring the emitted radiation with the camera; and where the doping material includes a phosphorescent material having a phosphorescence decay time.

Implementations of the invention may include one or more of the following features. The method may further include emitting the emitted radiation at a second location of the substrate, the second location of the substrate including the doping material, where the second location of the substrate is a predetermined distance from the first location of the substrate. The computing device may be a smartphone or a tablet. Measuring the emitted radiation with the camera may be performed during the phosphorescence decay time when irradiating with the radiation source is stopped or removed. The phosphorescence decay time may be at least one minute.

### BRIEF DESCRIPTION OF THE FIGURES

FIG. 1 is a graph showing a first code corresponding to the resulting spectral intensities after a band of incident radiation in the near infrared portion of the electromagnetic spectrum is transmitted through a clear approximately 75 micron polymer layer including doping material;

FIG. 2 is a graph showing a second code corresponding to the resulting spectral intensities after a band of incident radiation in the near infrared portion of the electromagnetic spectrum is transmitted through a clear approximately 75 micron polymer layer including doping material;

FIG. 3 is a graph showing a third code corresponding to the resulting spectral intensities after a band of incident radiation in the near infrared portion of the electromagnetic spectrum is transmitted through a clear approximately 75 micron polymer layer with doping material;

FIG. 4 is a graph showing a fourth code corresponding to the resulting spectral intensities after a band of incident radiation in the near infrared portion of the electromagnetic spectrum is transmitted through a clear approximately 75 micron polymer layer with doping material;

FIG. 5 shows an exemplary authentication system in accordance with embodiments of the invention;

FIG. 6 shows an exemplary system that may be employed to authenticate an item using the method of the present invention;

FIG. 7 shows an exemplary screen shot of a software application that may be utilized on a smartphone for authenticating an item in accordance with the present invention;

FIG. 8 shows a side view illustration of a substrate of one embodiment of the present invention, the substrate including doping material capable of transmitting incident radiation laterally through the substrate through a wave guided propagation mechanism;

FIG. 9 shows a top view illustration of an item of one embodiment of the present invention, the item including a clear window that is partially covered by a foil;

FIG. 10 shows another embodiment of the present invention in which a polymer substrate includes at least one grating that results in a waveguide mode of lateral radiation transmission; and

FIG. 11 shows another embodiment of the present invention in which a polymer substrate includes at least two gratings that results in a waveguide mode of lateral radiation transmission;

FIG. 12 shows another embodiment of the present invention in which an assembly includes a polymer substrate with at least one grating and optional cladding layers disposed on the polymer substrate that results in a waveguide mode of lateral radiation transmission;

FIG. 13 shows another embodiment of the present invention in which an assembly includes a polymer substrate with at least one first grating, optional cladding layers disposed on the polymer substrate, and at least one second grating associated with the polymer substrate or a cladding layer that results in a waveguide mode of lateral radiation transmission;

FIG. 14A shows another embodiment of the present invention in which an assembly includes, or is configured as, the security feature of a security thread;

FIG. 14B shows another embodiment of the present invention in which an assembly includes, or is configured as, the security feature of a security thread, and includes fluorescence aspects; and

FIG. 15 shows another embodiment of the present invention in which a polymer substrate includes at least one prism that results in a waveguide mode of lateral radiation transmission.

### DETAILED DESCRIPTION OF THE PREFERRED EMBODIMENTS

The present invention provides for apparatus and methods for coding polymer substrates with the addition of doping materials, and authentication systems and methods using the coded polymer substrates. The coded polymer substrates may be used, e.g., for authenticating secure items, instruments or documents, such as banknotes or currency.

The substrate may include a transparent and colorless polymer material. The substrate may include a polymer material having an index of refraction between approximately 1.3 and approximately 1.8, compared to the index of refraction of the surrounding medium, i.e., air, of 1.0. A polymer substrate employed in the present invention may be a BOPP layer. Such a BOPP substrate, as used in banknotes or currency, may have a core layer which is approximately 60-90 microns in thickness and top plasma or corona treated skin layers for print adhesion. In one embodiment, the polymer substrate may be covered with an opacity layer to allow for both contrast printing and discharge of static charges. In another embodiment, the polymer substrate may include a clear area or window free from opacity, as is often the case in higher denomination polymer banknotes. The opacity layer of the banknote, either alone or in combination with the area free from opacity, may function as the analog of paper banknote watermark for polymer banknotes.

Doping materials may be nanometer and micrometer materials added to the BOPP material. The doping materials may be added to the BOPP material during extrusion of the polymer layer. The doping materials are selected not to be index matched to allow for scattering of radiation transmitted through the polymer substrate, but at otherwise sufficiently low concentrations to maintain the clarity and transparency of the BOPP material.

The doping materials may be inorganics, organics, semiconductor and nanostructures exhibiting exciton, phonon polariton and plasmonic modes, and particularly those that can survive the extrusion temperatures of the BOPP material or other selected polymer material. The doping materials may be added to or loaded in the BOPP material at 0.01-10% loadings by weight. The quantity of doping material embedded in the polymer material may be so dilute that it does not substantially alter the index of refraction of the polymer material or otherwise render the substrate non-transparent or non-colorless. For example, the particles of the doping material may have a density of less than 900 parts per million. Moreover, the haze of the substrate with the embedded doping material may be less than 5, in which haze refers to the percentage of incident light diffused or scattered when passing through a transparent material.

Most significantly, each doping material exhibits a unique absorptive and/or scattering property or signature in the spectrum of incident radiation transmitted through the BOPP material in the region from the far infrared to the long ultraviolet. In particular, the doping materials selectively absorb and/or scatter incident radiation at specific wavelengths. By combining specific absorption and/or scattering features of various doping materials, codes for authentication of the banknotes are created in the form of patterned spectra with notches or other non-uniform features, i.e., absorption or scattering patterns. In addition, the doping materials may include materials such as phosphors that emit radiation of a particular wavelength, upon excitation by radiation transmitted directly or laterally through the polymer substrate. The emission features of such doping materials may be combined with the absorption and/or scattering features of the doping materials to create patterned spectra for the authentication codes.

Additionally, the doping material(s) may have a long decay time during which emitted radiation is emitted, e.g., greater than 1 second or at least one minute, such as is the case for a phosphorescent material. According to certain exemplary embodiments of the present invention, the doping material(s) may have a decay time of any length, such as on the scale of minutes or hours, e.g., at least one minute, or a tenth of a second, a quarter of a second, half a second, one second, or multiple seconds, e.g., 2, 3, 4, 5, or more seconds. The long decay time would enable a user sufficient time to irradiate/excite the substrate and obtain a measurement of the emitted radiation after removal or stoppage of the radiation/excitation source, e.g., after the light source has been turned off. Such embodiments may be preferred over examples utilizing a fluorescent material as a doping material, which require that the radiation/excitation source be on or activated during detection or measurement of the emitted radiation. The use of a phosphorescent material allows for minimal optical clutter and interference during detection and/or measurement.

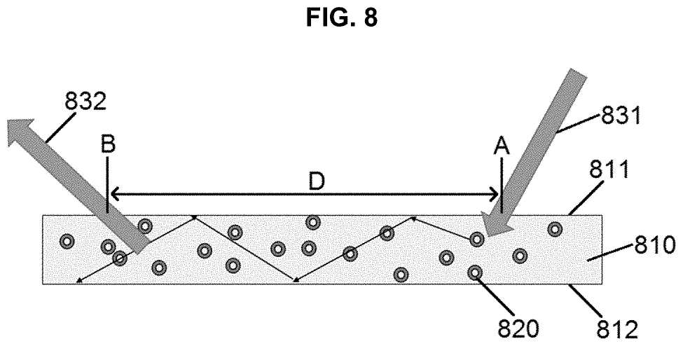

The substrate may have a thickness of approximately 60 microns to approximately 100 microns between an upper surface and a lower surface of the substrate, e.g., between upper surface 811 and lower surface 812 illustrated in FIG. 8. In this case, incident radiation may be transmitted directly through the transparent substrate, i.e., from the lower surface to the upper surface. The substrate with doping material embedded therein may be configured to function as a waveguide for radiation transmitted through the substrate, i.e., through total internal reflection between the upper and lower surfaces of the substrate. In particular, the substrate is configured as a planar dielectric waveguide capable of transmitting electromagnetic radiation laterally through the substrate in a waveguide mode between the upper and lower surfaces. As shown in FIG. 8, this allows incident radiation 831 coupled to the substrate 810 at a point A to be detected as output light 832 at point B located laterally a distance D from point A. Output light 832 includes a spectral signature. Doping material 820 is disposed through substrate 810, doping material 820 being capable of scattering and/or absorbing radiation.

The incident radiation may enter the substrate for waveguide transmission through external coupling at the upper or lower surface of the substrate followed by internal scattering. Such scattering mediated waveguide coupling is an alternative mode for radiation to enter the planar waveguide of the substrate compared to directing the radiation through an edge of the substrate. The same mode of scattering can result in external coupling and may be used to decouple radiation transmitted through the substrate for detection.

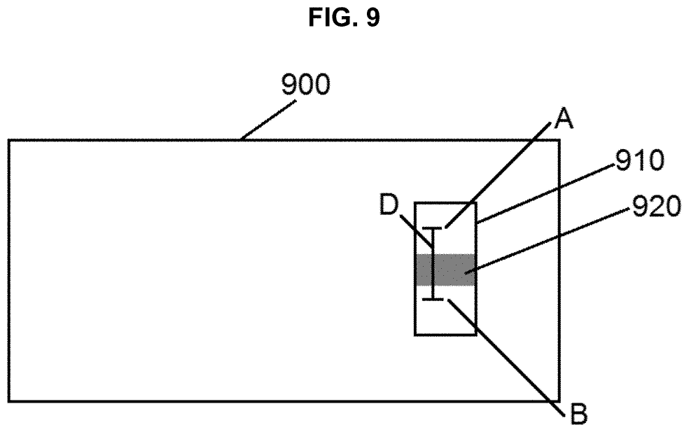

The doping material include particles capable of scattering radiation coupled to the substrate for waveguide mode transmission. In particular, momentum of the incident radiation is conserved such that when radiation strikes the scattering particles, the radiation is launched into a waveguide mode. Utilizing the materials disclosed herein, the radiation may propagate through the substrate a distance ranging from millimeters to centimeters. The path length of radiation propagated through the substrate is determined by the absorptive properties of the doping material embedded in the polymer material. The transmission of radiation in a waveguide mode significantly increases the path length of the radiation through the substrate before the radiation is absorbed by the doping material. In connection with a process for authenticating an item such as a banknote including a substrate as described herein, the incident radiation may be transmitted through the substrate in a waveguide mode through a clear window of the item, e.g., a clear polymer window in some foreign currency. Alternatively, the incident radiation may be transmitted in a waveguide mode through a portion of the substrate having a metal foil or opacity layer on one or both of the upper and lower surfaces of the substrate. FIG. 9 provides an example including a metal foil or opacity layer. Item 900 includes a clear window 910, in which clear window 910 is partially covered by foil 920. As shown in FIG. 9, incident radiation at illumination point A is detected as output light at detection point B located laterally a distance D from illumination point A. Such illumination, transmission, and detection is possible even with foil 920 separating points A and B using the waveguide process described previously.

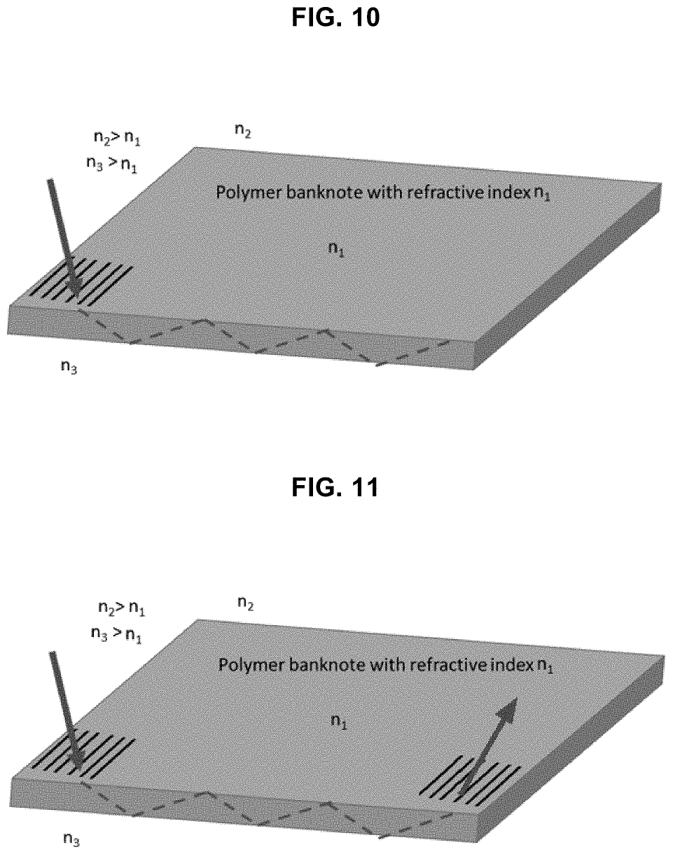

In another embodiment of the present invention, as illustrated in FIG. 10, at least one grating is provided on a polymer substrate (e.g., polymer banknote), the grating diffracting incident radiation (e.g., light) into the polymer substrate at an angle greater than the critical angle and thereby launching the radiation into a waveguide mode. The grating is provided on the polymer substrate, on one or both surfaces of the polymer substrate or otherwise within the polymer substrate, such as but not limited to by embossing, deposition, or curing with an interference pattern using ultraviolet (UV) curable ink. Moreover, the grating may be written onto a surface or within the polymer substrate using UV induced changes in the refractive index of the polymer material of the polymer substrate through utilization of two interfering lasers. FIG. 10 illustrates a grating on a polymer substrate, whereby the incident radiation enters the polymer substrate at the grating and is launched into a waveguide mode of transmission, the radiation transmitted laterally within the polymer substrate, namely between the upper and lower surfaces of the polymer substrate. In FIG. 10, the polymer substrate has an index of refraction (n₁) that is less than both the index of refraction of the environment (e.g., air) above the upper surface of the polymer substrate (n₂) and the index of refraction of the environment (e.g., air) below the lower surface of the polymer substrate (n₃), which permits or assists in the lateral transmission of radiation between the upper and lower surfaces of the polymer substrate through a waveguide mechanism.

In another embodiment of the present invention, as illustrated in FIG. 11, which is related to the embodiment illustrated in FIG. 10, two gratings are provided on a polymer substrate (e.g., polymer banknote). The first grating diffracts incident radiation (e.g., light) into the polymer substrate at an angle greater than the critical angle, thereby launching the radiation into a waveguide mode, while the second grating decouples the radiation from the waveguide mode after its lateral transmission within the polymer substrate, namely between the upper and lower surfaces of the polymer substrate, thereby resulting in the exiting of the radiation from the polymer substrate. The gratings are provided on the polymer substrate, on the same or opposite surfaces of the polymer substrate or otherwise within the polymer substrate, such as but not limited to by embossing, deposition, or curing with an interference pattern using ultraviolet (UV) curable ink. Moreover, the gratings may be written onto a surface or within the polymer substrate using UV induced changes in the refractive index of the polymer material of the polymer substrate through utilization of two interfering lasers. The first grating may be disposed on the same surface of the polymer substrate as the second grating and located at a set distance from the second grating. In effect, incident radiation entering the polymer substrate at the first grating will exit the polymer substrate at the second grating at the same or different wavelength. This effect may be configured or otherwise utilized as an authentication feature associated with the substrate (e.g., polymer banknote). An individual handling the substrate can observe light entering the substrate at one grating region and exiting the substrate at another grating region.

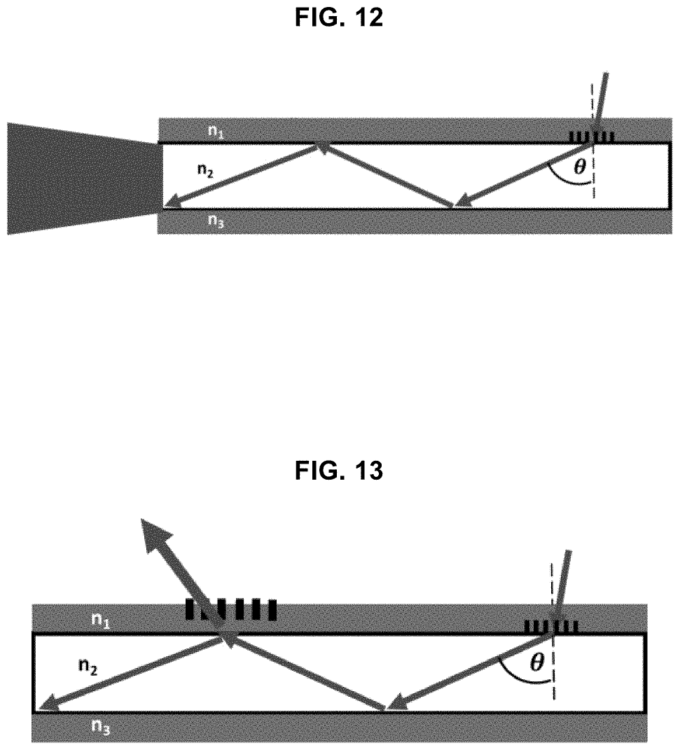

In another embodiment of the present invention, as illustrated in FIG. 12, which is related to the embodiments illustrated in FIGS. 10 and 11, at least one grating is provided on a polymer substrate (e.g., polymer banknote). The grating diffracts incident radiation (e.g., light, such as from a laser pointer, an LED, or a smartphone light) into the polymer substrate at an angle greater than the critical angle and thereby launches the radiation into a waveguide mode. The gratings may be but are not limited to a relief grating, a volume grating, a deposited grating, and the like. The grating period may be configured to permit normal incidence light to be coupled into a waveguide mode. Concerning the grating diffraction angle (θ), θ>θ_{c}, where θ_{c} is the smallest critical angle for total internal reflection if the two external indices of refraction are different. Optional cladding layers are provided in this embodiment on both surfaces of the polymer substrate. Transparent or clear cladding layers may be thicker than the evanescent decay length, which is typically several microns. By utilizing transparent or clear cladding layers, the waveguided radiation is isolated from any opacification as well as any conductive layers or printing layers thereon. Such cladding layers are optional depending on whether the goal is to see the waveguided propagation across the assembly using scattering printed or coated layers, in which case the cladding layers are coatings for conductivity and/or opacity. Irrespective of whether such cladding layers are included, the grating is preferably transparent or clear.

With respect to the mechanism illustrated in FIG. 12, incident radiation enters the polymer substrate at a grating and is launched into a waveguide mode of transmission, the radiation transmitted laterally within the polymer substrate between the upper and lower surfaces of the polymer substrate. In FIG. 12, the polymer substrate has an index of refraction (n₂) that is different (e.g., greater) than both the index of refraction of the cladding layer disposed above the upper surface of the polymer substrate (n₁) and the index of refraction of the cladding layer disposed below the lower surface of the polymer substrate (n₃), which permits or assists in the lateral transmission of radiation between the upper and lower surfaces of the polymer substrate through a waveguide mechanism. Ultimately, the waveguided radiation exits the polymer substrate at an end or edge of the polymer substrate after its lateral transmission. While a non-limiting example of the present invention takes the form of a polymer banknote, such as a polymer banknote comprising BOPP, further examples include security features, such as a security thread or a windowed security thread, and a credit card. While this embodiment utilizes at least one grating, the embodiment may similarly utilize at least one prism structure, lens, or ball lens.

In another embodiment of the present invention, as illustrated in FIG. 13, which is related to the embodiments illustrated in FIGS. 10-12, at least one first grating is provided on a polymer substrate (e.g., polymer banknote). The grating diffracts incident radiation (e.g., light, such as from a laser pointer, an LED, or a smartphone light) into the polymer substrate at an angle greater than the critical angle and thereby launches the radiation into a waveguide mode. Optional cladding layers are provided in this embodiment on both surfaces of the polymer substrate. In one example of this embodiment, at least one second grating is provided on the polymer substrate and/or one or both cladding layers for decoupling or coupling out at least a portion, if not all, of the waveguided radiation from the assembly, permitting such radiation to exit the assembly after its lateral transmission.

With respect to the mechanism illustrated in FIG. 13, incident radiation enters the polymer substrate at a first grating associated with the polymer substrate and is launched into a waveguide mode of transmission, the radiation transmitted laterally within the polymer substrate between the upper and lower surfaces of the polymer substrate. In FIG. 13, the polymer substrate has an index of refraction (n₂) that is different (e.g., greater) than both the index of refraction of the cladding layer disposed above the upper surface of the polymer substrate (n₁) and the index of refraction of the cladding layer disposed below the lower surface of the polymer substrate (n₃), which permits or assists in the lateral transmission of radiation between the upper and lower surfaces of the polymer substrate through a waveguide mechanism. Ultimately, at least a portion, if not all, of the waveguided radiation exits the polymer substrate at a second grating associated with the polymer substrate and/or a cladding layer. A portion of the waveguided radiation may continue in its lateral transmission within the polymer substrate. In this embodiment, decoupling or coupling out of the waveguided radiation may be achieved in several ways, including but not limited to having a specific region where the index of refraction of the cladding layer matches the index of refraction of the polymer substrate, having a second grating or coupling structure in a specific region of the polymer substrate set a distance away from the first grating or coupling structure and in the direction of the propagating waveguided radiation, having a scattering region at a specific location in the polymer substrate set a distance away from a first grating or coupling structure and in the direction of the propagating waveguided radiation, and the like.

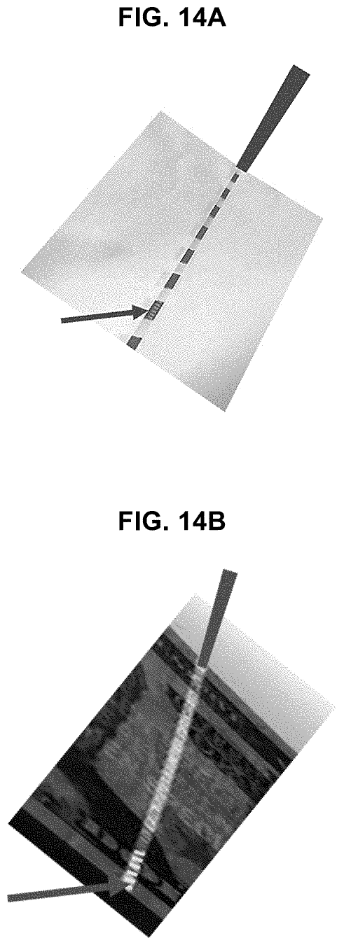

FIGS. 14A and 14B illustrate two exemplary embodiments in which the assembly includes, or is configured as, the security feature of a security thread. In both FIGS. 14A and 14B, incident radiation enters the security thread (e.g., polymer security thread) at a grating on the security thread and/or associated item (e.g., banknote) and is launched into a waveguide mode of transmission. The radiation is transmitted laterally within the security thread, such as between the upper and lower surfaces of the security thread. Ultimately, the waveguided radiation exits the security thread and/or associated item at an end or edge of the security thread and/or associated item after its lateral transmission. Such an assembly may include one or more of a cladding layer and a printing layer on one or both surfaces of the security thread. FIG. 14B illustrates an embodiment including fluorescence aspects. In particular, the propagating waveguided radiation excites a fluorescent material disposed within the security thread and/or a cladding layer. In one example of this embodiment, the security thread is disposed entirely within the paper banknote except for an exposed grating region.

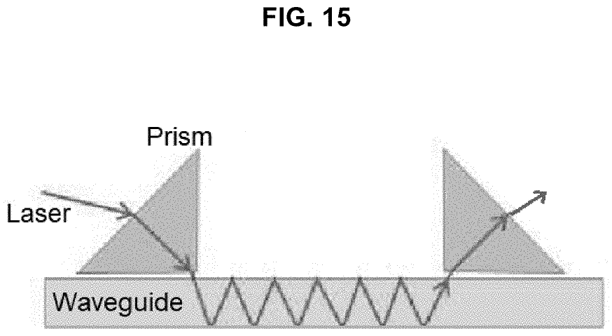

In another embodiment of the present invention, as illustrated in FIG. 15, at least one prism (e.g., two prisms) is provided in connection with a polymer substrate (e.g., polymer banknote) for similarly launching incident radiation into a waveguide mode. For example, a first prism including an air gap may be disposed on a surface of a polymer substrate, the first prism refracting incident radiation (e.g., light) into the polymer substrate at an angle greater than the critical angle, thereby coupling and launching the radiation into a waveguide mode. Additionally, a second prism including an air gap may be disposed on the same surface of the polymer substrate as the first prism and located at a set distance from the first prism, the second prism operating to decouple the radiation from the waveguide mode after its lateral transmission within the polymer substrate, namely between the upper and lower surfaces of the polymer substrate.

As described above, in connection with polymer substrates of the present invention, including those composed of BOPP, a cladding layer that is particle-free (e.g., having no doping material) may be provided on, above, or otherwise connected to the polymer substrate. The cladding layer may have an index of refraction that is lower than the index of refraction of the polymer substrate (e.g., BOPP), which would prevent any printing layer disposed on the cladding layer and having particles therein from interfering with the desired waveguide mode propagation or transmission. The printing layer having particles therein may be provided on, above, or otherwise connected to the cladding layer. The cladding layer may have a thickness of approximately two evanescent decay lengths. In one embodiment of the present invention in which the polymer substrate is composed of BOPP or a polymer having a similarly high index of refraction and the cladding layer has an index of refraction of approximately 1.4, it is preferable that a thickness of the cladding layer be 2 μm or greater. Polymers that may be utilized in a cladding layer of the present invention, such as a cladding layer provided on, above, or otherwise connected to a polymer substrate composed of BOPP or a polymer having a similarly high index of refraction (n), include but are not limited to poly(1,1,1,3,3,3-hexafluoroisopropyl acrylate) (n=1.375), poly(2,2,3,3,4,4,4-heptafluorobutyl acrylate) (n=1.377), poly(2,2,3,3,4,4,4-heptafluorobutyl methacrylate) (n=1.383), poly(2,2,3,3,3-pentafluoropropyl acrylate) (n=1.389), poly(1,1,1,3,3,3-hexafluoroisopropyl methacrylate) (n=1.390), poly(2,2,3,4,4,4-hexafluorobutyl acrylate) (n=1.394), poly(2,2,3,4,4,4-hexafluorobutylmethacrylate), poly(2,2,3,3,3-pentafluoropropyl methacrylate) (n=1.395), poly(2,2,2-trifluoroethyl acrylate) (n=1.411), poly(2,2,3,3-tetrafluoropropyl methacrylate) (n=1.417), and poly(2,2,2-trifluoroethyl methacrylate) (n=1.418).

Upon detection, i.e., through decoupling from the substrate after waveguide transmission, the spectrum of radiation may be analyzed for patterns such as notches resulting from narrow-band absorption by the doping material.

The process of authenticating an item such as a banknote including a substrate as described herein may be performed using apparatus capable of generating incident radiation for transmission through the substrate and detecting radiation transmitted through the substrate. Such authentication may be performed on high-speed transport mechanisms, such as those used to process currency at a rate of 40 banknotes per second.

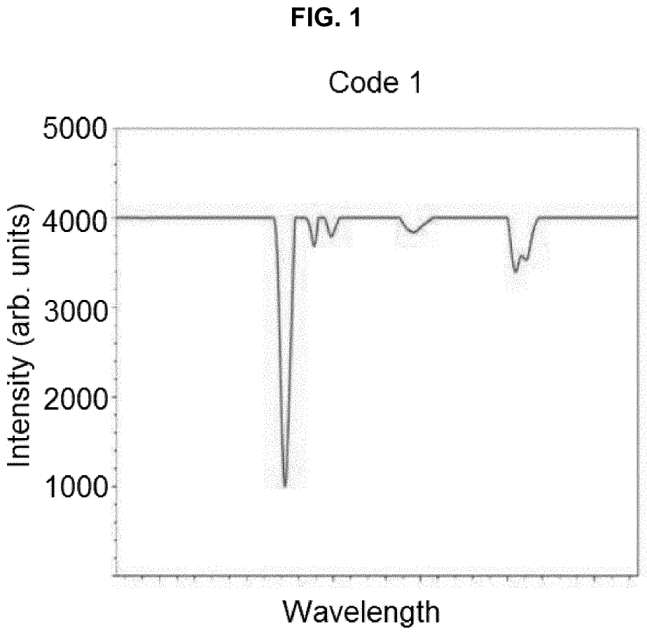

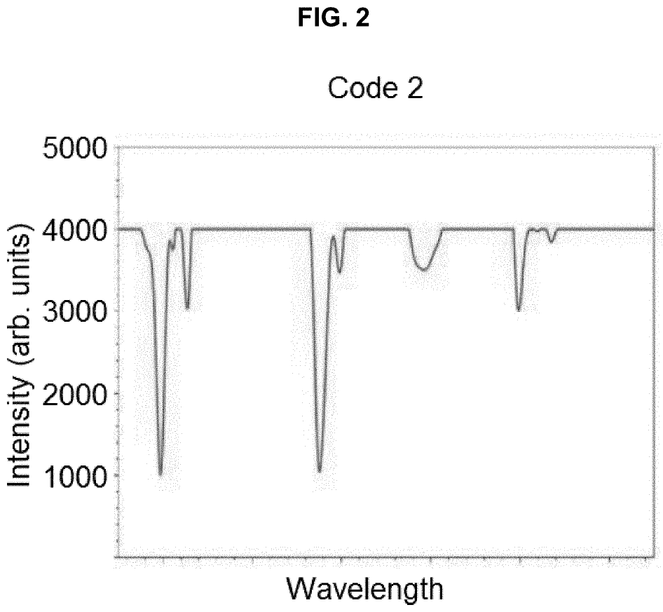

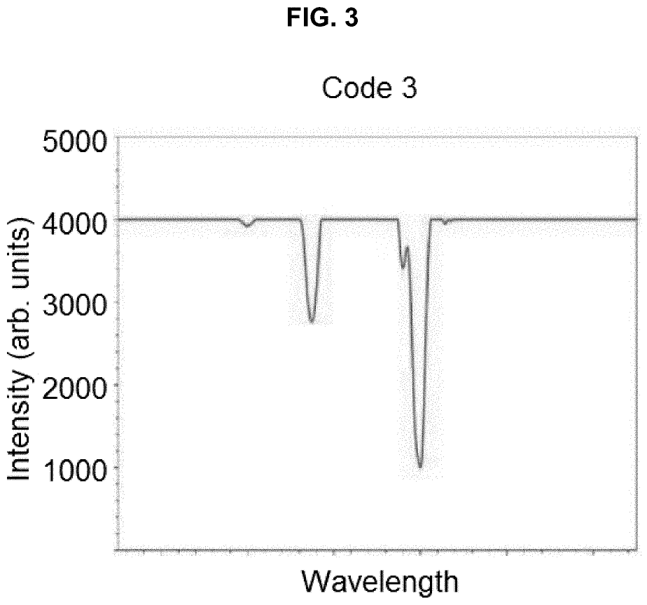

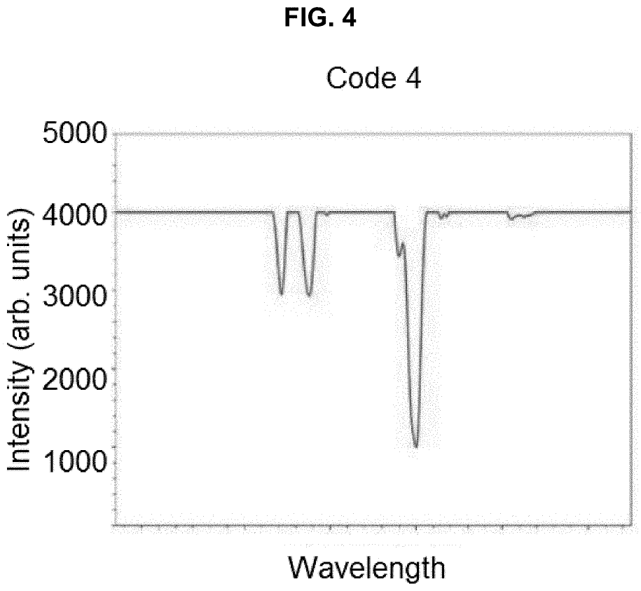

FIGS. 1-4 show spectra for a band of incident radiation in the near infrared portion of the electromagnetic spectrum transmitted through a clear approximately 75 micron polymer layer with varying types and levels of doping materials. The intensities of radiation detected after transmission of incident radiation through the polymer layer vary from the otherwise substantially uniform intensity of the incident radiation over the band of wavelengths due to the presence of doping materials. The doping materials are selected to absorb and/or scatter radiation at predetermined wavelengths to create the notched and otherwise non-uniform detected spectral patterns.

Experiments have demonstrated the use of up to ten unique codes embedded in a spectrum of radiation transmitted through a BOPP material that further maintains excellent clarity in regions of the BOPP material lacking an opacity layer and is indistinguishable from un-doped BOPP material. Using shape and Fano resonance effects, metallic and semiconductor nanostructure resonances of doping materials can be tuned and manipulated to create a large array of codes. These codes may be specific to certain institutions, such as Central Banks. The codes may also be used to authenticate banknotes and/or determine the denominations of banknotes on high speed sorting machines, such as those manufactured by Geisecke and Devrient, Cash Processing Solutions (CPS), and Toshiba.

Exemplary embodiments of the present invention are generally directed to devices, apparatus, systems, and methods for authentication using coded polymer substrates. Specifically, exemplary embodiments of the present invention use detecting/sensing mechanisms that may be used to authenticate items including a coded polymer substrate. Although the exemplary embodiments of the present invention are primarily described with respect to authentication and/or preventing counterfeiting, it is not limited thereto, and it should be noted that the exemplary coded polymer substrates may be used to encode other types of information for other applications. Further, the exemplary embodiments of the present invention may be used in conjunction with other authentication measures, e.g., holograms, watermarks, and magnetic encoding.

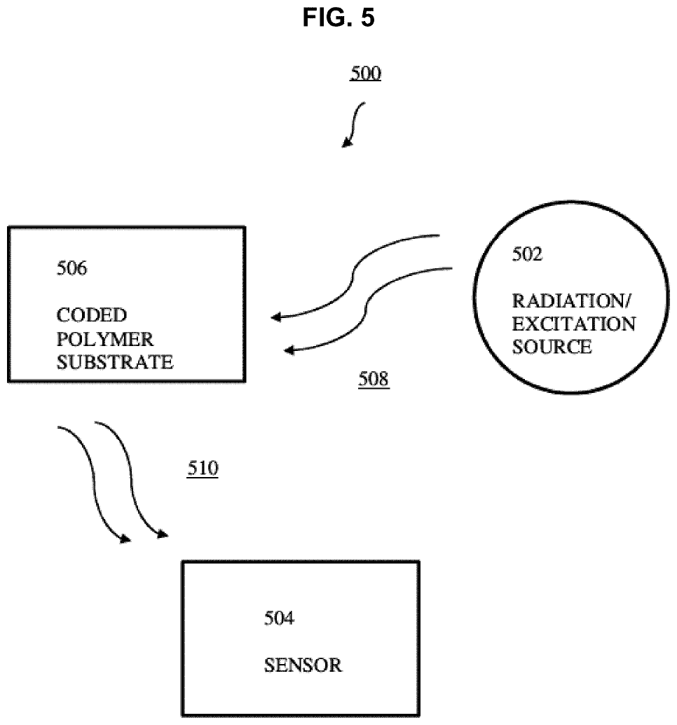

FIG. 5 shows an exemplary system 500 in accordance with embodiments of the present invention. As shown in FIG. 5, system 500 may include a radiation/excitation source 502, a sensor 504, and a coded polymer substrate 506. Radiation/excitation source 502 may be any source supplying radiation 508, such as, e.g., visible light, ultraviolet radiation, radio waves, or microwaves, which is to be transmitted through the coded polymer substrate. Radiation detected after transmission through the coded polymer substrate may include radiation 510 in the same wavelength range or radiation 510 in a different wavelength range.

Sensor 504 may include any detecting, sensing, imaging, or scanning device that is able to receive, image and/or measure the spectrum of the radiation emitted by the coded polymer substrate 504, such as a photometer or a digital camera.

According to certain exemplary embodiments of the present invention, radiation/excitation source 502 may include the flash of a digital camera, and sensor 504 may include the optical components and sensors of the digital camera. In one exemplary embodiment, the radiation/excitation source 502 may include the light source of a smartphone or tablet camera, e.g., Apple iPhone, Apple iPad, Samsung Galaxy or other Android devices, and sensor 504 may include the camera of the smartphone or tablet. The light source of the smartphone or tablet camera may include a blue emitter and a phosphor.

In an embodiment utilizing a smartphone or tablet camera, the light source and the lens of a smartphone or tablet camera can be put into contact with or directly up/flat against a surface of the coded polymer substrate 506 during irradiation/excitation of the coded polymer substrate 506 with the light source of the smartphone or tablet, i.e., normal incidence. In embodiments utilizing a grating, the grating may be tuned to such normal incidence. After the irradiation/excitation has been removed or stopped, the spectrum of the emitted radiation is measured with the smartphone or tablet camera statically or by translation in one or more scanning motions, such as by moving the smartphone or tablet camera one or more times over substrate 506. More specifically, in a first example, the light source may statically irradiate substrate 506, the light source may be turned off, and the camera or lens may statically measure the emitted radiation. In a second example, the light source may irradiate substrate 506 by translation in one or more motions across the surface of substrate 506, the smartphone or tablet camera may then be stopped over a portion of the irradiated area of substrate 506, and the light source may be turned off, including as a result of an accelerometer in the smartphone or tablet determining that the device is no longer in motion, at which point the camera or lens statically measures the emitted radiation. In this second example, the smartphone or tablet camera may be operating in a video mode such that a time response of the emitted radiation may also be measured. The accelerometer of the smartphone or tablet may also be utilized in determining translations, movements, starting and stopping, and the like, as well as associated attributes, e.g., acceleration, velocity, orientation, of the smartphone or tablet.

By placing the light source and the lens of the smartphone or tablet camera into contact with or directly up against the surface of substrate 506, background or ambient light can be minimized. Any residual background or ambient light that is not blocked may be addressed by calibrating the smartphone or tablet camera and its lens to account for such light. In one exemplary embodiment, the light source of the smartphone or tablet camera does not turn on until background or ambient light has been reduced to an acceptable level, indicating that the device is ready for use. In one exemplary embodiment, the smartphone or tablet camera operates in a video mode during the excitation and/or measurement process to measure a time response of the emitted radiation. In one exemplary embodiment, the smartphone or tablet camera is configured to measure color coordinate ratios, hue saturation values, or both, in connection with the analysis of a spectral signature.

Coded polymer substrate 506 may be included in labels and may be attached or affixed to any product or item, e.g., tax stamps, apparel, currency, or footwear, for which authentication may be desirable.

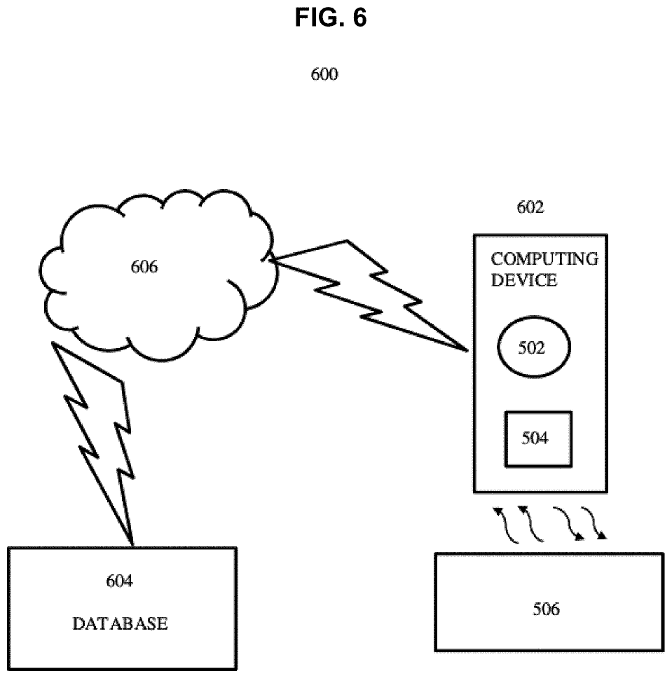

FIG. 6 shows an exemplary system 600 that may be employed to authenticate an item using the coded polymer substrate described herein. For example, system 600 includes a computing device 602, which may include radiation/excitation source 502 and sensor 504. Computing device 602 may be any computing device that incorporates a radiation/excitation source 502 and sensor 504, such as a smartphone, a tablet, or a personal data assistant (PDA). Alternatively, radiation/excitation source 502 and sensor 504 may be standalone devices that operate independent of a computing device. As described herein, the radiation/excitation source 502 may irradiate a coded polymer substrate, and sensor 504 may measure the radiation emitted by the coded polymer substrate, including the spectral signature. The computing device 602 may then determine a code corresponding to the measured spectral signature of the radiation emitted by the coded polymer substrate. The processing of the measured spectral signature to determine the code may be performed by a remote computing device. Subsequently, the code or the measured spectral signature may be compared to a database of reference codes or spectral signatures. The database of reference codes may be stored locally on the scanning, imaging, or sensing device or remotely on a separate computing device or cloud storage.

As shown in FIG. 6, to complete the authentication, the computing device 602 may compare the code or the measured spectral intensities to the reference codes or spectral signature stored in a database 604. Although FIG. 6 illustrates this comparison being performed via a network 606 to a remote database 604, other embodiments contemplate database 604 being local to computing device 602.

Further, in some embodiments, the item being authenticated may include an identifying label, such as, e.g., a barcode, a QR code, or a magnetic code, to enable correlation of the code or the measured spectra to the item being authenticated. In a particular embodiment where computing device 602 is a smartphone or tablet, the transmission via the network 606 may be performed over a cellular data connection or a Wi-Fi connection. Alternatively, this can be performed with a wired connection or any other wired or wireless data transport mechanism.

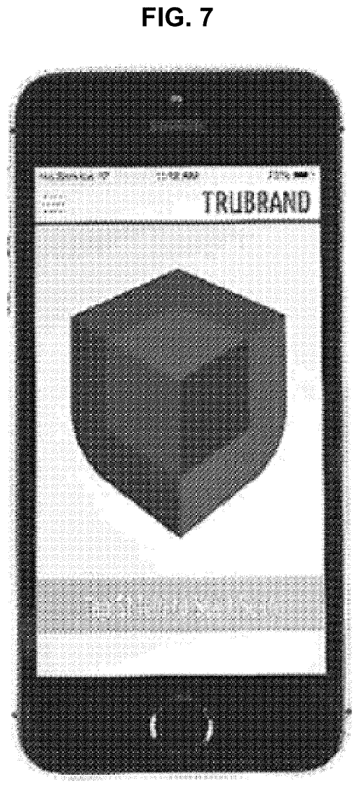

In certain embodiments of the present invention where a computing device, such as a smartphone or tablet, is utilized for authenticating an item, a software application may be used to simplify the authentication process. FIG. 7 shows a smartphone with an exemplary screen shot of a software application that may be utilized for authenticating an item. The exemplary application may be configured to be executed on any mobile platform, such as Apple's iOS or Google's Android mobile operating system. When the application is run, the software application may provide instructions to a user on properly irradiating or exciting the coded polymer substrate and scanning or imaging the spectrum emitted from the coded polymer substrate. Once the irradiating and scanning of the polymer substrate is complete, the application may facilitate comparison of the measured spectral signature and/or the measured code with a database that stores certain reference codes or spectral signatures to authenticate the item. Further, the application may provide a message or other indicator informing the user of the result of the authentication. For example, the application may provide a text, graphical, or other visual indicator on the screen of the smartphone showing the results of the authentication. Alternatively, the application may provide audible and/or tactile indicators conveying the results of the authentication.

One exemplary embodiment of the present invention includes verifying the authenticity of banknotes, e.g., currency, using a remote device such as a smartphone. Implementing the detection techniques described herein, an application on the smartphone may be used both to verify the authenticity of banknotes and determine the denomination (i.e., monetary value) of the banknotes. Thus, according to the present invention, a smartphone may be used to both authenticate and denominate banknotes using a physical signature placed on or embedded in the banknotes.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the accompanying drawings and descriptive matter in which there are illustrated exemplary embodiments of the invention.

What is claimed is:

1. A method, comprising:
providing an item including a substrate comprising a polymer material and a first diffraction feature disposed directly or indirectly on or within the substrate, the first diffraction feature configured to diffract incident radiation into the substrate at an angle greater than a critical angle and launch the incident radiation into a waveguide transmission mode within the substrate to transmit the incident radiation laterally within the substrate;
irradiating, with a radiation source, the item at a location of the first diffraction feature directly or indirectly on or within the substrate; and
measuring, with a camera, emitted radiation from the substrate after lateral transmission of the incident radiation;
wherein the radiation source and the camera are included in a computing device; and
wherein the computing device is disposed in contact with the substrate when irradiating with the radiation source and measuring the emitted radiation with the camera.

2. The method of claim 1, wherein the first diffraction feature is a first grating.

3. The method of claim 2, wherein the first grating is disposed directly or indirectly on or within the substrate by embossing, deposition, curing with an interference pattern using ultraviolet curable ink, or writing using ultraviolet induced changes in the refractive index of the polymer material of the substrate utilizing two interfering lasers.

4. The method of claim 1, wherein the first diffraction feature is a first prism including an air gap, a first lens, or a first ball lens disposed directly or indirectly on the substrate.

5. The method of claim 1, further comprising:
emitting the emitted radiation at a second diffraction feature disposed directly or indirectly on or within the substrate, the second diffraction feature configured to decouple the incident radiation from the waveguide transmission mode after lateral transmission within the substrate;
wherein the second diffraction feature is disposed a predetermined distance from the first diffraction feature.

6. The method of claim 1, wherein the substrate further comprises a doping material configured to laterally transmit the incident radiation within the substrate or a fluorescent material configured to fluoresce in response to the irradiating.

7. The method of claim 1, wherein the item is currency, a security thread, or a credit card.

8. The method of claim 1, wherein the computing device is a smartphone or a tablet.

9. A system, comprising:
an item including a substrate comprising a polymer material and a first diffraction feature disposed directly or indirectly on or within the substrate, the first diffraction feature configured to diffract incident radiation into the substrate at an angle greater than the critical angle and launch the incident radiation into a waveguide transmission mode within the substrate to transmit the incident radiation laterally within the substrate; and
a computing device capable of being disposed in contact with the substrate, the computing device comprising:
a radiation source configured to irradiate the item at a location of the first diffraction feature directly or indirectly on or within the substrate such that radiation is transmitted laterally within the substrate; and
a camera configured to measure emitted radiation from the substrate after lateral transmission of the incident radiation;
wherein, in connection with irradiating with the radiation source and measuring the emitted radiation with the camera, the computing device is disposed in contact with the substrate.

10. The system of claim 9, wherein the first diffraction feature is a first grating.

11. The system of claim 10, wherein the first grating is disposed directly or indirectly on or within the substrate by embossing, deposition, curing with an interference pattern using ultraviolet curable ink, or writing using ultraviolet induced changes in the refractive index of the polymer material of the substrate utilizing two interfering lasers.

12. The system of claim 9, wherein the first diffraction feature is a first prism including an air gap, a first lens, or a first ball lens disposed directly or indirectly on the substrate.

13. The system of claim 9, wherein the item further comprises a second diffraction feature disposed directly or indirectly on or within the substrate, the second diffraction feature configured to decouple the incident radiation from the waveguide transmission mode after lateral transmission within the substrate;
wherein the second diffraction feature is disposed a predetermined distance from the first diffraction feature.

14. The system of claim 9, wherein the substrate further comprises a doping material configured to laterally transmit the incident radiation within the substrate or a fluorescent material configured to fluoresce in response to the irradiating.

15. The system of claim 9, wherein the item is currency, a security thread, or a credit card.

16. The system of claim 9, wherein the computing device is a smartphone or a tablet.

17. A method, comprising:
providing an item including a substrate comprising a polymer material and a doping material, the polymer material and the doping material configured to couple incident radiation and launch the incident radiation into a waveguide transmission mode within the substrate to transmit the incident radiation laterally within the substrate;
irradiating, with a radiation source, the item at a first location of the substrate, the first location of the substrate including the doping material; and
measuring, with a camera, emitted radiation from the substrate after lateral transmission of the incident radiation;
wherein the radiation source and the camera are included in a computing device;
wherein the computing device is disposed in contact with the substrate when irradiating with the radiation source and measuring the emitted radiation with the camera; and
wherein the doping material includes a phosphorescent material having a phosphorescence decay time.

18. The method of claim 17, further comprising:
emitting the emitted radiation at a second location of the substrate, the second location of the substrate including the doping material;
wherein the second location of the substrate is a predetermined distance from the first location of the substrate.

19. The method of claim 17, wherein the computing device is a smartphone or a tablet.

20. The method of claim 17, wherein measuring the emitted radiation with the camera is performed during the phosphorescence decay time when irradiating with the radiation source is stopped or removed.

21. The method of claim 17, wherein the phosphorescence decay time is at least one minute.
